(19) United States
(12) Patent Application Publication
(10) Pub. No.: US 2026/0074841 A1
(43) Pub. Date: Mar. 12, 2026

(54) METHODS AND PROCEDURES FOR UNEQUAL MODULATION OVER SPATIAL STREAMS AND FREQUENCY SEGMENTS

(71) Applicant: InterDigital Patent Holdings, Inc., Wilmington, DE (US)

(72) Inventors: Ying Wang, Easton, PA (US); Rui Yang, Greenlawn, NY (US); Hanqing Lou, Syosset, NY (US)

(73) Assignee: InterDigital Patent Holdings, Inc., Wilmington, DE (US)

(21) Appl. No.: 18/827,262

(22) Filed: Sep. 6, 2024

(51) Int. Cl. H04L 5/00; H04L 27/26

(52) U.S. Cl. CPC H04L 5/0007; H04L 27/26412

(57) ABSTRACT

Methods and procedures are disclosed herein for applying unequal modulation over spatial streams and/or frequency segments. A STA may determine, for each spatial stream of a plurality of spatial streams, a plurality of frequency subblocks, each frequency subblock including one or more respective resource units (RUs) and an associated modulation order, and each RU including a respective number of occupied data tones. The STA may parse a bit sequence corresponding to an OFDM symbol into the plurality of spatial streams. For each spatial stream, the STA may allocate, for each frequency subblock, a respective number of consecutive bits of the OFDM symbol that corresponds to the associated modulation order of the frequency subblock and the respective number of occupied data tones in the RUs of the frequency subblock. The STA may transmit the plurality of spatial streams according to the allocation over the occupied data tones.

### BACKGROUND

A wireless local area network (WLAN) [1] in Infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA. Such traffic between STAs within a BSS is peer-to-peer traffic, which may also be sent directly between the source and destination STAs with a direct link setup (DLS) using an 802.11e DLS or an 802.11z tunneled DLS (TDLS). A WLAN using Independent BSS (IBSS) mode has no AP, and the STAs using such an IBSS may communicate directly with each other. This mode of communication is referred to as an “ad-hoc” mode of communication.

Using the 802.11ac infrastructure mode of operation, the AP may transmit a beacon on a fixed channel, usually the primary channel. This channel may be 20 MHz wide and is the operating channel of the BSS. This channel is also used by the STAs to establish a connection with the AP. The fundamental channel access mechanism in an 802.11 system is Carrier Sense Multiple Access with Collision Avoidance (CSMA/CA). In this mode of operation, every STA, including the AP, will sense the occupancy or vacancy of the primary channel. If the channel is detected to be busy, the STA backs off. Hence only one STA may transmit at any given time, frequency, and space resources in each BSS.

In 802.11n [1], High Throughput (HT) STAs may also use a 40 MHz wide channel for communication. This is achieved by combining the primary 20 MHz channel, with an adjacent 20 MHz channel to form a 40 MHz wide contiguous channel.

In 802.11ac [2], Very High Throughput (VHT) STAs may support 20 MHz, 40 MHz, 80 MHz, and 160 MHz wide channels. The 40 MHz and 80 MHz channels are formed by combining contiguous 20 MHz channels as described above for 802.11n. A 160 MHz channel may be formed either by combining 8 contiguous 20 MHz channels, or by combining two non-contiguous 80 MHz channels, which may be referred to as an 80+80 configuration. For the 80+80 configuration, at the transmitter, the data, after channel encoding, may be passed through a segment parser that divides the data into two streams. Inverse fast Fourier transform (IFFT) and time domain processing are done on each stream separately. The two streams are then mapped onto the two 80 MHz channels for transmission. At the receiver, this mechanism is reversed, and the combined data from the two 80 MHz channels is sent to the medium access control (MAC) layer.

In 802.11ax [2], High Efficiency (HE) Wireless STAs may support 20 MHz, 40 MHz, 80 MHz, and/or 160 MHz wide channels capable of transmission over 2.4 GHZ, 5 GHZ, and 6 GHz frequency bands using both orthogonal frequency-division multiple access (OFDMA) and multi-user multiple-input multiple-output (MU-MIMO) capabilities. OFDMA subcarrier modulation in HE STAs includes formats such as BPSK, QPSK, 16-QAM, 64-QAM, 256-QAM, and 1024-QAM. The evolution of 802.11 to Extremely High Throughput (EHT, or 802.11be) STAs extends to having 320 MHz wide channels.

Sub 1 GHz modes of operation are supported by 802.11af and 802.11ah [3]. For these specifications the channel operating bandwidths, and the number of Orthogonal frequency-division multiplexing (OFDM) subcarriers, are reduced relative to those used in 802.11n and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. A possible use case for 802.11ah is support for Meter Type Control (MTC) devices in a macro coverage area. MTC devices may have limited capabilities with limited bandwidths, but they may require a very long battery life.

WLAN systems that support multiple channels and channel widths, such as 802.11n, 802.11ac, 802.11af, 802.11ah, 802.11ax, and 802.11be, include a channel that is designated as the primary channel. The primary channel may, but not necessarily, have a bandwidth equal to the largest common operating bandwidth supported by all STAs in the BSS. The bandwidth of the primary channel is therefore limited by the STA that supports the smallest bandwidth operating mode in the BSS. In the example of 802.11ah, the primary channel may be 1 MHz wide if there are STAs (e.g. MTC type devices) that only support a 1 MHz mode even if the AP, and other STAs in the BSS, may support 2 MHz, 4 MHz, 8 MHz, 16 MHz, or other channel bandwidth operating modes. All carrier sensing and NAV settings depend on the status of the primary channel, i.e., if the primary channel is busy, for example, due to a STA supporting only a 1 MHz operating mode is transmitting to the AP, then the entire available frequency bands are considered busy even though majority of it stays idle and available.

To improve spectral efficiency, 802.11n started to introduce the multiple-input multiple-output (MIMO) technology, which multiplies capacity by transmitting up to 4 data streams (or spatial streams) over different antennas. 802.11ac further introduced downlink multi-user MIMO (MU-MIMO) transmission, where multiple users may send their data streams (max 4 per user, total up to 8) over different antennas simultaneously on the same frequency, i.e., on the same OFDM subcarrier and in the same OFDM symbol. 802.11ax and 802.11be use both orthogonal frequency-division multiple access (OFDMA), which is multiplexing users in the frequency domain, and UL/DL MU-MIMO, which is multiplexing users in the spatial domain.

The IEEE 802.11 Ultra High Reliability (UHR), or 802.11bn, Study Group was formed in September 2022. UHR is considered as the next major revision to IEEE 802.11 standards following 802.11be (or EHT), which is currently in the Working Group Letter Ballot Stage. UHR explores the possibility to improve reliability, support further reduced low latency traffic, further increase peak throughput, improve power saving capabilities, and improve efficiency of the IEEE 802.11 network over EHT.

### SUMMARY

Methods and procedures are disclosed herein for applying unequal modulation over spatial streams and/or frequency segments. A STA may determine, for each spatial stream of a plurality of spatial streams, a plurality of frequency subblocks, each frequency subblock including one or more respective resource units (RUs) and an associated modulation order, and each RU including a respective number of occupied data tones. The STA may parse a bit sequence corresponding to an OFDM symbol into the plurality of spatial streams. For each spatial stream, the STA may allocate, for each frequency subblock, a respective number of consecutive bits of the OFDM symbol that corresponds to the associated modulation order of the frequency subblock and the respective number of occupied data tones in the RUs of the frequency subblock. The STA may transmit the plurality of spatial streams according to the allocation over the occupied data tones of the one or more respective RUs of the plurality of frequency subblocks of the plurality of spatial streams.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2A is a system diagram illustrating an example transmitter for transmitting a data field of an extremely high throughput (EHT) single user (SU) transmission in a resource unit (RU) or multiple resource unit (MRU);

FIG. 2B is a transmitter block diagram for the Data field of an EHT SU transmission in RU or MRU size larger than a 996-tone RU with LDPC encoding;

FIG. 3 An example of stream parser for UEQM over three spatial streams, mapping input bits to three output bit sequences, each for a spatial stream;

FIG. 4 is a system diagram illustrating an example parser subsystem including a proportional round-robin segment parser;

FIG. 5 is a system diagram illustrating an example parser subsystem including a proportional round-robin segment parser with unequal modulation across frequency subblocks for a spatial stream;

FIG. 6 is a system diagram illustrating an example parser subsystem including an equal-size round-robin stream parser concatenated with proportional round-robin segment parser with unequal modulation across frequency subblocks and spatial streams;

FIG. 7 is a system diagram illustrating an example parser subsystem including a proportional round-robin stream parser concatenated with proportional round-robin segment parser with unequal modulation across frequency subblocks and spatial streams;

FIG. 8 is a flow diagram illustrating an example procedure for parsing a bit stream for unequal modulation over spatial streams and frequency subblocks; and

FIG. 9 is a flow diagram illustrating an example procedure for parsing a bit stream for unequal modulation over spatial streams only.

### DETAILED DESCRIPTION

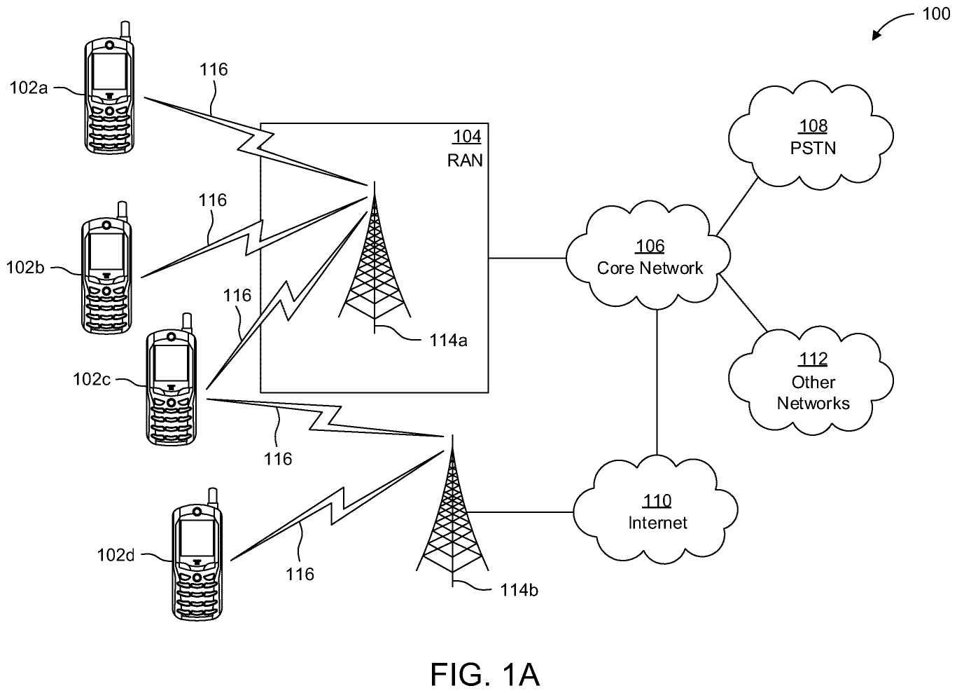

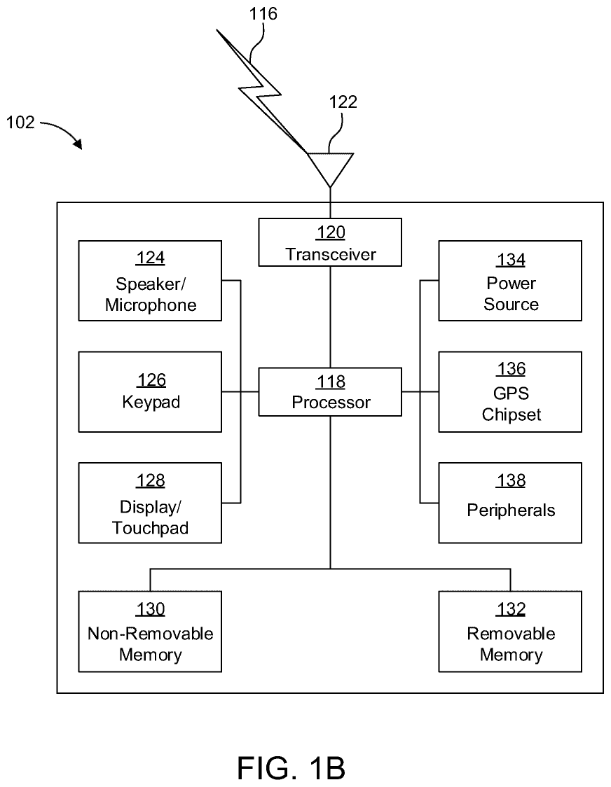

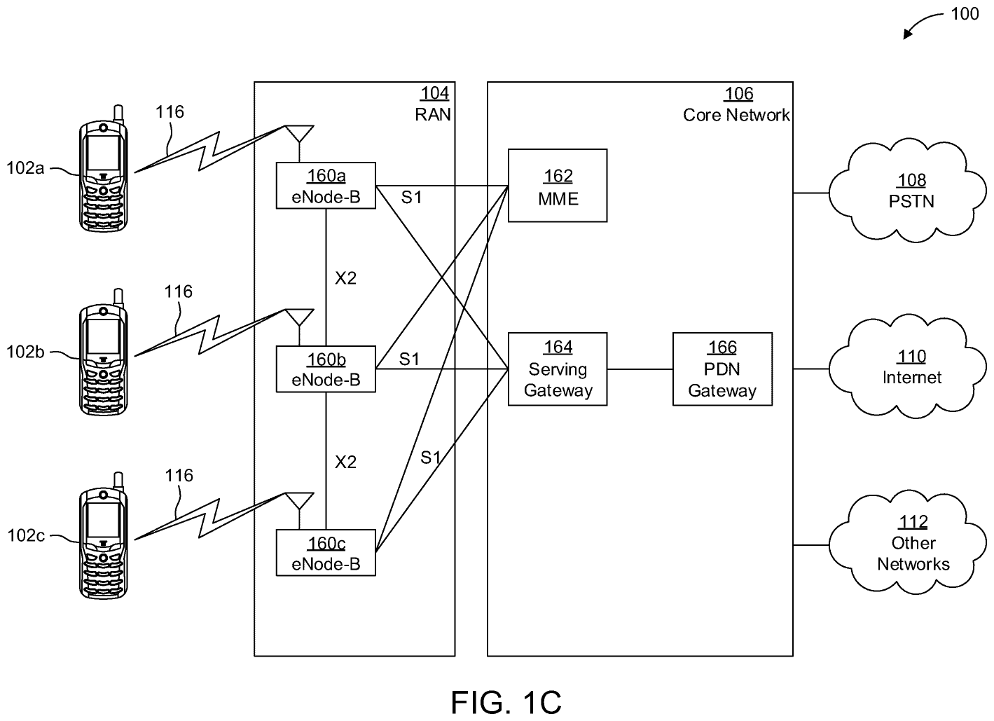

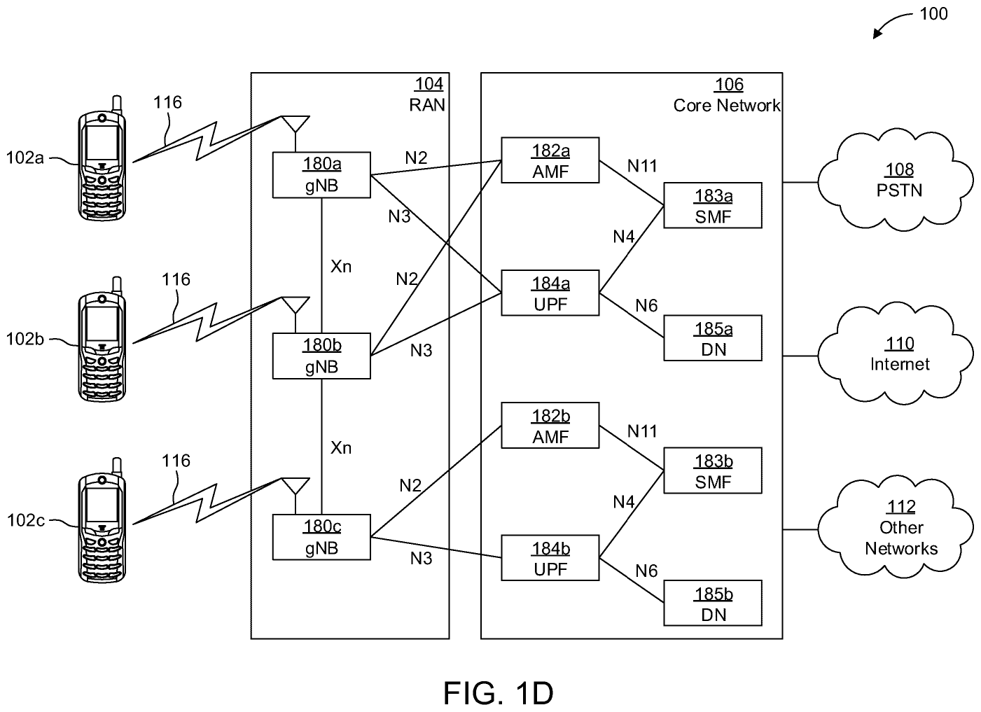

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (and/or a “STA”), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device (e.g., gaming devices), a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to, for example, facilitate access to one or more communication networks, such as the CN 106, the Internet 110, and/or the other networks 112. By way of example, the base stations 114a, 114b may be a base transceiver station (BTS), a Node B, an eNode-B (eNB), a Home Node-B (HNB), a Home eNode-B (HeNB, a next generation Node-B (NR NB), such as a gNode-B (gNB), a new radio (NR) Node-B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, the gNBs 180a, 180b, 180c may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In other representative embodiments, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHz wide channel.

Very High Throughput (VHT or 802.11ac) STAs may support 20 MHz, 40 MHz, 80 MHz, and/or 160 MHz wide channels transmitted over a 5 GHz frequency band using OFDMA. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

High Efficiency Wireless (HEW or 802.11ax) STAs may support 20 MHz, 40 MHz, 80 MHz, and/or 160 MHz wide channels capable of transmission over 2.4 GHZ, 5 GHZ, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHZ and 6 GHZ) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

The next generation of 802.11 standard, 802.11bn (i.e., Ultra High Reliability-UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave—IMMW), energy harvesting based on of WiFi RF signals for facilitating WLAN communications of low-power IoT devices, and the randomization of MAC addresses in WLANs.

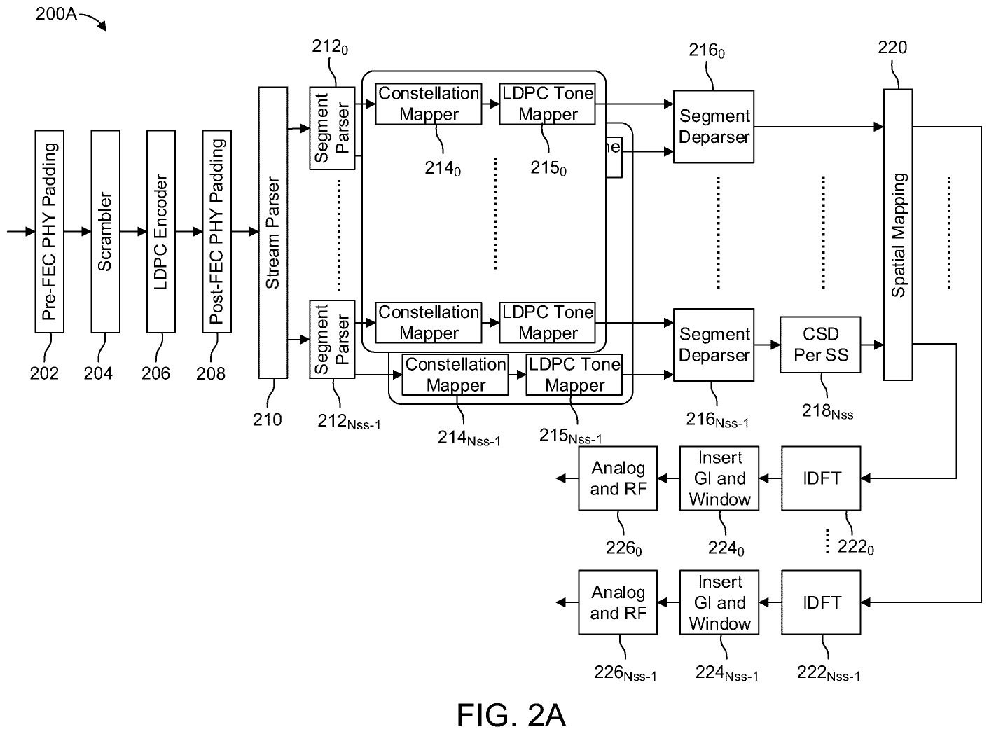

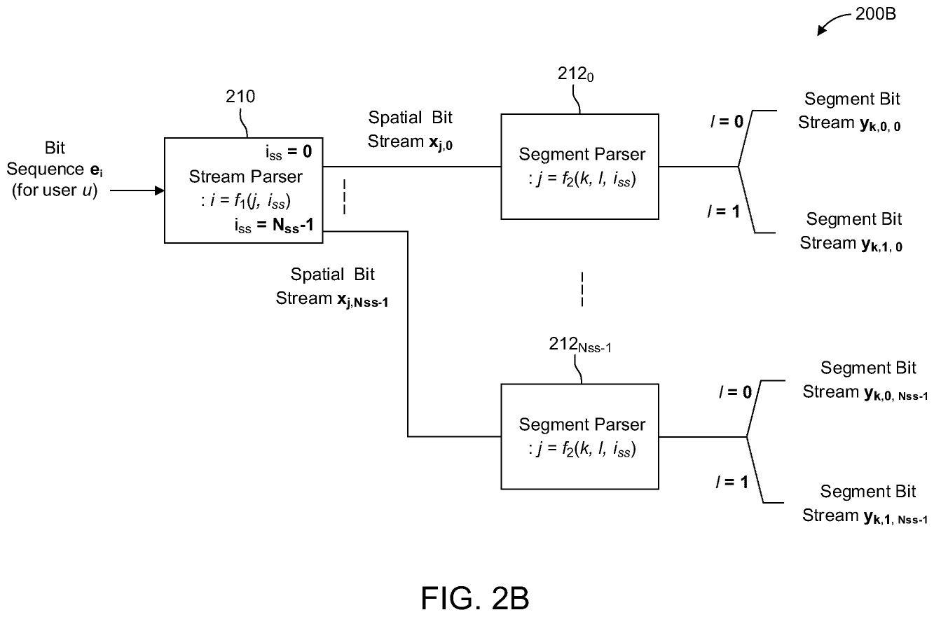

For MIMO transmission in 802.11be, the data bit streams or sequences at the output of the forward error correction (FEC) encoders may be parsed by stream parsers and/or segment parsers into streams or blocks of bits to get the bits ready to be mapped to constellation points in spatial streams on subcarriers, as shown for example in FIG. 2A. FIG. 2A is a system diagram illustrating an example transmitter 200A for transmitting a data field of an extremely high throughput (EHT) single user (SU) transmission in a resource unit (RU) or multiple resource unit (MRU). The RU or MRU may have a size larger than a 996-tone RU with low-density parity-check code (LDPC) encoding. Pre-FEC physical (PHY) layer padding unit 202 ensures the correct number of input bits to the low-density parity check (LDPC) encoder 206. Scrambler 204 scrambles the input data bits to reduce the probability of long sequences of ‘0’s or ‘1’s. LDPC encoder 206 encodes the data bits to enable error correction using LDPC encoding. Post-FEC PHY Padding unit 208 adds padding bits to the data bits ensure that the total number of bits will fill in whole OFDM symbols. Stream parser 210 may rearrange input bits into Nₛₛ blocks of bits, with each block of bits corresponding to a spatial stream (Nₛₛ is the number of spatial streams). The bits of each spatial stream may be further parsed by segment parsers 212₀, . . . ,212_{Nss-1}, which rearranges the input bits for transmission over frequency subblocks (e.g., 80 MHz frequency subblocks). The purpose of the stream parser 210 and segment parsers 212₀, . . . ,212_{Nss-1} is to avoid bursty block errors in the encoded bits by not having too many consecutive encoded bits to go through the same channel conditions (i.e., the same spatial stream and/or the same frequency subblock).

Bits in each frequency subblock of each spatial stream are mapped to a QAM constellation point sequence on the data tones by constellation mappers 2140, . . . ,214_{Nss-1}. LDPC tone mappers 2150, . . . ,215_{Nss-1} is to permute this constellation point sequence to different tones. Segment deparsers 2160, . . . ,216_{Nss-1} merge 80 MHz frequency subblocks back into one frequency segment. Cyclic Shift Diversity (CSD) per SS unit 218_{Nss} applies CSD to each spatial stream. Spatial mapping unit 220 applies a spatial mapping matrix to map the vector of Nₛₛ complex numbers in each subcarrier into a vector of NTx complex numbers in each subcarrier, where N_{TX} is the number of transmit antennas. Inverse discrete Fourier transform (IDTF) units 222₀, . . . ,222_{Nss-1-c} compute the ITDF of the input signals. Insert guard interval (GI) and window units 224₀, . . . ,224_{Nss-1} prepend a predetermined guard interval and apply windowing to generate an OFDM symbol. Analog and radio frequency (RF) units 226₀, . . . ,226_{Nss-1} upconvert the resulting complex baseband waveform with each transmit chain to an RF signal according to the center frequency of the desired channel and transmit.

Because different spatial streams and different frequency subblocks may experience different channel conditions, such as the effects of multipath fading and interference, one way to improve the throughput is to use higher modulation orders in the spatial steams or frequency subblocks that have higher signal-to-noise ratio (SNR) or signal-to-interference-and-noise ratio (SINR), and vice versa. In the case of MU, this is partially accomplished for MU-MIMO where different users may occupy different spatial streams and for OFDMA where different users may occupy different frequency subblocks, and different users may use different modulations. However, for a single user (SU), even though 802.11n originally supported unequal modulation (UEQM) over different spatial streams, UEQM over spatial streams disappeared from subsequent 802.11 amendments. UEQM over frequency subblocks for an SU was never implemented in prior 802.11 standards.

To further improve efficiency and increase throughputs, a stream parser may take UEQM into account and allocate bits accordingly to have the correct number of constellation points (according to the modulation order) for frequency blocks of each spatial stream. If further UEQM over frequency subblocks is defined, a new segment parser is needed to allocate bits accordingly so that each subcarrier gets the correct number of bits for its assigned modulation order. In this case, even in the case of equal modulation across spatial streams on each subcarrier, a combined stream/segment parser may be used instead of the separated stream and segment parsers. When UEQM over both spatial streams and frequency subblocks are simultaneously defined, a combined stream/segment parser may be used.

For the example embodiments described herein, a “frequency subblock” may refer for example to an 80 MHz frequency subblock for illustrative purposes, however frequency subblock may be any other frequency width including, but not limited to, 320 MHz, 160 MHz, 40 MHz, or 20 MHz, or may be any resource unit (RU) or other defined frequency segment.

The example embodiments described herein are described in terms of an SU transmission. For MU transmissions, the rearrangements are carried out in the same way per user. For example, a subscript u for a given user u may be added to any of the equations disclosed herein to distinguish between different users. Herein, tone and subcarrier may be used interchangeably, and data tone and data subcarrier may be used interchangeably. An X-tone RU may have a total number of X tones, including both data tones and pilot tones. When a data bit sequence is assigned to a RU, the bits may be allocated to the data tones (i.e., data subcarriers) only.

For example embodiments described herein, it may be assumed that the given user u has Nₛₛ spatial streams and L frequency segments. FIG. 2B is a system diagram illustrating an example parser subsystem 200B, including stream parser 210 and segment parsers 212₀, . . . ,212Nₛₛ−1, that may be part of a transmitter such as example transmitter 200A in FIG. 2A. For a given user u, an encoded bit sequence {eᵢ}, i=0,1, . . . , N_{CBPS}−1 corresponding to one OFDM symbol may be provided as input to stream parser 210 then segment parsers 212₀, . . . ,212_{Nss-1} (stream parser 210 and segment parsers 212₀, . . . ,212_{Nss-1} may be a combined ins a single combination parser), where N_{CBPS} is the number of coded bits per OFDM. The spatial bit stream or sequence in spatial stream iss is denoted by {x_{j,i}_{ₛₛ}}, j=0,1, . . . , N_{CBPSS,i}_{ₛₛ}−1, where N_{CBPSS,i}_{ₛₛ} is the number of coded bits per OFDM symbol for spatial stream iₛₛ and

$${N}_{CBPS} = {\sum }_{{i}_{s s} = 0}^{{N}_{s s} - 1} {N}_{CBPSS , {i}_{s s}} .$$

The segment bit stream or sequence of frequency segment/in spatial stream iₛₛ is denoted by {y_{k,l,i}_{ₛₛ}}, k=0,1, . . . , N_{CBPS,l,i}_{ₛₛ}−1,l=0,1, . . . . L−1, where N_{CBPSS,l,i}_{ₛₛ} is the number of coded bits per OFDM symbol in frequency segment l for spatial stream iₛₛ, L is the number of frequency segments (L=2 in the example of FIG. 2B) and

$${N}_{CBPSS , {i}_{s s}} = {\sum }_{l = 0}^{L - 1} {N}_{CBPSS , l , {i}_{s s}} .$$

When the stream parser and the segment parser are separable, we may have a mapping function ƒ₁(·) implemented in stream parser 210 between the indexes of bit sequences {eᵢ} and {x_{j,i}_{ₛₛ}} such that i=ƒ₁(j,iₛₛ), and another mapping function ƒ₂(·) implemented in each of segment parsers 212₁, . . . ,212Nₛₛ between the indexes of bit sequences {x_{j,i}_{ₛₛ}} and {y_{k,l,i}_{ₛₛ}} such that j=ƒ₂(k,l,iₛₛ). In an example not shown where the stream parser 210 and the segment parsers 212₁, . . . ,212Nₛₛ are combined, a combined mapping function ƒ(·) between the bit indexes of sequences {eᵢ} and {y_{k,l,i}_{ₛₛ}} is applicable such that i=ƒ(k,l,iₛₛ).

Example embodiments of applying unequal modulation across the spatial streams and over different frequency subblocks, or resource units (RUs), or multiple resource units (MRUs) are described hereinafter.

In an example embodiment, for a given user u and Nₛₛ spatial streams, it may be assumed that different modulation sizes are allowed across spatial streams and within each spatial steam the modulation size is the same across frequency subblocks, RUs, or MRUs. In this case, a stream parser and a segment parser may be separately applied to assign bits to spatial stream and frequency resources.

NcBPS is the number of bits in coded bit sequence {eᵢ}. The coded bit sequence {eᵢ}, i=0,1, . . . , N_{CBPS}−1 is provided as input to the stream parser and the N_{CBPS} bits may be rearranged into Nₛₛ blocks of bits, each block of bits for a spatial stream having N_{CBPSS,i}_{ₛₛ} bits, where N_{CBPSS,i}_{ₛₛ} is the number of coded bits per OFDM symbol for spatial stream iss. The number of bits assigned to a single axis (real or imaginary) in a constellation point in spatial stream iₛₛ is denoted by

$${s}_{{i}_{s s}} = max ( 1 , \frac{{N}_{BPSCS , {i}_{ss}}}{2} ) ,$$

where iₛₛ=0,1, . . . , Nₛₛ−1 and N_{BPSCS,i}_{ₛₛ} is the number of coded bits per subcarrier for spatial stream iₛₛ. The number of assigned bits over all spatial streams is

$$S = {\sum }_{{i}_{s s} = 0}^{{N}_{s s} - 1} {s}_{{i}_{s s}} .$$

Blocks of S consecutive bits of bit sequence {eᵢ} are assigned to Nₛₛ spatial streams in a round robin fashion, such that sᵢ_{ₛₛ} consecutive bits are assigned or allocated to spatial stream iₛₛ for iss from 0 to Nₛₛ−1. That is, bit with index i of the input bit sequence {eᵢ} (the index refers to the bit's position in the bit sequence) is assigned to a bit with index j of the output bit sequence {x_{j,i}_{ₛₛ}} at spatial stream iₛₛ, where i is a function of iₛₛ and j, and the mapping function is expressed as x_{j,i}_{ₛₛ}=eᵢ where

$$i = S \cdot ⌊ \frac{j}{{s}_{{i}_{s s}}} ⌋ + {\sum }_{k = 0}^{{i}_{s s} - 1} {s}_{k} + j mod {s}_{{i}_{s s}} \qquad ( 1 )$$

$${i}_{s s} = 0 , 1 , … , {N}_{s s} - 1$$

$$i = 0 , 1 , … , {N}_{CBPS} - 1$$

$$and j = 0 , 1 , … , {N}_{CBPSS , {i}_{ss}} - 1 .$$

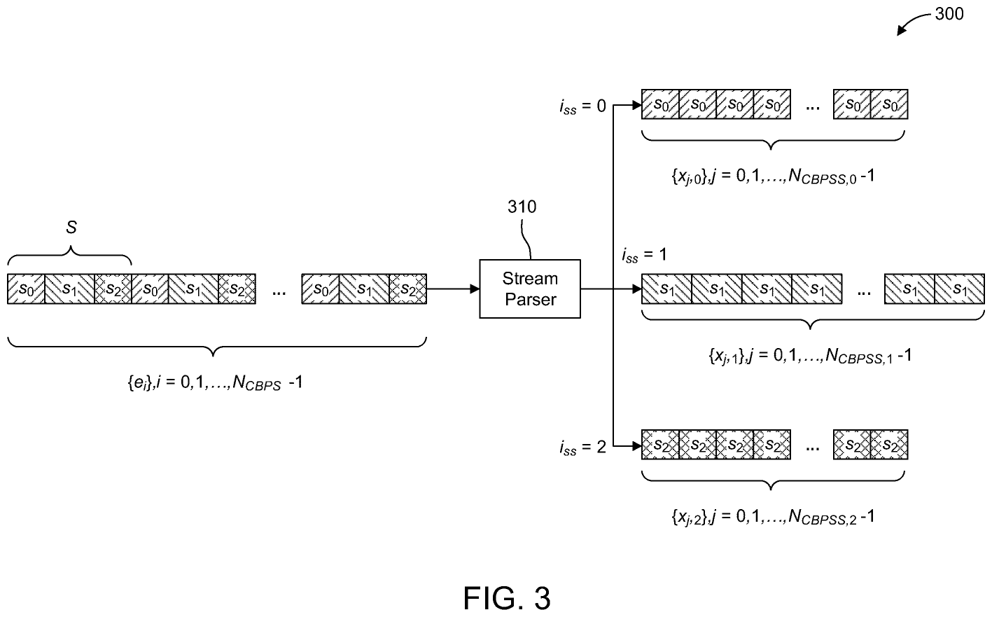

FIG. 3 is a system diagram illustrating an example parser subsystem 300 including stream parser 310. The stream parser 310 allocates input bits {eᵢ}, i=0,1, . . . , N_{CBPS}−1 for UEQM to the output bit sequence {x_{j,i}_{ₛₛ}} according to i=ƒ₁(j,iₛₛ) over the spatial streams iₛₛ=0, 1, 2 for j=0, 1, . . . , N_{CBPSS,i}_{ₛₛ}−1, where N_{CBPSS,i}_{ₛₛ} is the number of coded bits per OFDM symbol for spatial stream iss. Because the modulation order of all subcarriers within a spatial stream iₛₛ is the same, the stream parser may for example use a round robin approach for assigning bits to spatial streams iss=0, 1, 2 without considering how each spatial stream further maps bits to subcarriers. A segment parser may further assign the N_{BPSCS,i}_{ₛₛ} bits in spatial stream iₛₛ=0,1, . . . , Nₛₛ−1 to different (e.g., 80 MHz) frequency subblocks (and the RUs or MRUs of the frequency subblocks).

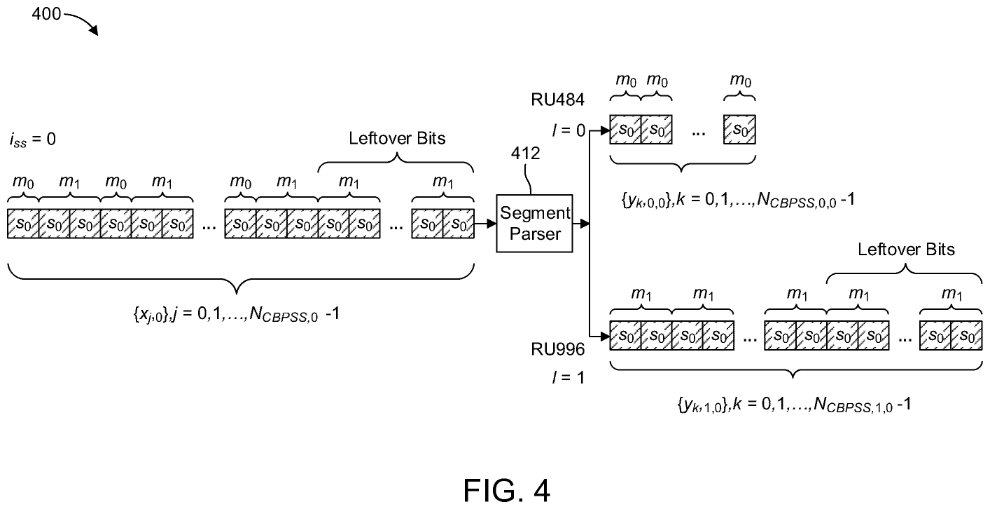

FIG. 4 is a system diagram illustrating an example parser subsystem 300 including segment parser 412, which may be used for a single spatial stream iₛₛ=0. The stream parser 410 allocates or assigns input bit sequence {x_{j,i}_{ₛₛ}} for j=0,1, . . . , N_{CBPSS,i}_{ₛₛ}−1 of spatial stream iₛₛ=0 to the output sequence {y_{k,l,i}_{ₛₛ}}, k=0,1, . . . , N_{CBPSS,l,i}_{ₛₛ}−1, l=0,1, . . . . L−1, where N_{CBPSS,l,i}_{ₛₛ}, is the number of coded bits per OFDM symbol in frequency segment I for spatial stream iₛₛ, L is the number of frequency segments or RUs (L=2 in the example of FIG. 4). FIG. 4 shows an example of a proportional round-robin segment parser 412 for a spatial stream that allocates bits alternatingly to a 484-tone RU (i.e., a frequency subblock including 484 subcarriers in a first 80 MHz frequency block) and a 996-tone RU (i.e., a frequency subblock including 996 subcarriers in a second 80 MHz frequency block). The modulation order for each frequency subcarrier is the same in the example of FIG. 4.

In another example embodiment, to further adapt to the different channel conditions across spatial streams and frequency blocks, UEQM may be applied over both spatial streams and (80 MHz) frequency subblocks.

In existing 802.11be solutions, the segment parser operation of 802.11be for each user is applied to each 80 MHz frequency subblock. In this case, segment parsing is only performed for an RU or MRU of size larger than 996 tones. For an RU or MRU of size 26-tone, 52-tone, 52+26-tone, 106-tone, 106+26-tone, 242-tone, 484-tone, 484+242-tone, and 996-tone there is only one segment, and the segment parser is bypassed. In this case, for each user, only the stream parser is needed and Equation (1) is used to map the encoded bit sequence {eᵢ}, i=0,1, . . . , N_{CBPS-1} to the bit sequences {x_{j,i}_{ₛₛ}} of the different spatial streams. Then the bit sequence at each spatial stream for the single frequency segment is {y_{k,0,i}_{ₛₛ}}, and y_{k,0,i}_{ₛₛ}=x_{k,i}_{ₛₛ}.

The following example embodiment considers unequal modulation over spatial streams and 80 MHz frequency subblocks, and may be used for RUs or MRUs with 2×996-tone, 996+484-tone, 996+484+242-tone, 2×996+484-tone, 3×996-tone, 3×996+484-tone, or 4×996-tone in 160 MHz (i.e., two 80 MHz frequency subblocks) or 320 MHz (i.e., three 80 MHz frequency subblocks) transmissions. In this case, the segment parser is described first and then the stream parser later.

With regards to the segment parser, the number of coded bits per OFDM symbol provided to the segment parser by the stream parser for spatial stream iₛₛ is N_{CBPSS,i}_{ₛₛ} bits for a given user u. These bits are further divided into L blocks of bits by the segment parser, with N_{CBPSS,l,i}_{ₛₛ}, bits are assigned to bit block l=0, 1, . . . , L−1 respectively such that

$${\sum }_{l = 0}^{L - 1} {N}_{CBPSS , l , {i}_{s s}} = {N}_{CBPSS , {i}_{s s}} .$$

L is the number of frequency subblocks (e.g., 80 MHz frequency subblocks) across the RU or MRU. Each block of the L blocks of bits corresponds to a frequency subblock. Let the number of coded bits per subcarrier per spatial stream be N_{BPSCS,l,i}_{ₛₛ} for the lₜₕ bit block, or the lth frequency subblock. For unequal modulation over the 80 MHz frequency subblocks, N_{BPSCS,l,i}_{ₛₛ} may be different over the L frequency subblocks. When dual carrier modulation (DCM) is not used, N_{BPSCS,l,i}_{ₛₛ}, or the modulation order, may be for example 1 for BPSK, 2 for QPSK, 4 for 16-QAM, 6 for 64-QAM, 8 for 256-QAM, 10 for 1024-QAM, and 12 for 4096-QAM. When the DCM is used, the modulation is BPSK only and N_{BPSCS,l,i}_{ₛₛ}=1 for all l=0, . . . , L−1. Example values of L and N_{CBPSS,l,i}_{ₛₛ} are given in Table 1 for various RU and MRU tone cases.

TABLE 1
Values of L and N_{CBPSS,l,i}_{ₛₛ} for UEQM over 80 MHz frequency subblocks

| | RU order (low to | | DCM | | | | |
|---|---|---|---|---|---|---|---|
| RU or MRU | high frequency) | L | used ? | N_{CBPSS,0,i}_{ₛₛ} | N_{CBPSS,1,i}_{ₛₛ} | N_{CBPSS,2,i}_{ₛₛ} | N_{CBPSS,3,i}_{ₛₛ} |
| 996 + 484 | 484 + 996 | 2 | No | 468 × N_{BPSCS,0,i}_{ₛₛ} | 980 × N_{BPSCS,1,i}_{ₛₛ} | N/A | |
| | | | Yes | 234 | 490 | | |
| | 996 + 484 | | No | 980 × N_{BPSCS,0,i}_{ₛₛ} | 468 × N_{BPSCS,1,i}_{ₛₛ} | | |
| | | | Yes | 490 | 234 | | |
| 996 + 484 + 242 | (242 + 484) + 996 | | No | 702 × N_{BPSCS,0,i}_{ₛₛ} | 980 × N_{BPSCS,1,i}_{ₛₛ} | | |
| | or | | Yes | 351 | 490 | | |
| | (484 + 242) + 996 | | | | | | |
| | 996 + (242 + 484) | | No | 980 × N_{BPSCS,0,i}_{ₛₛ} | 702 × N_{BPSCS,1,i}_{ₛₛ} | | |
| | or | | Yes | 490 | 351 | | |
| | 996 + (484 + 242) | | | | | | |
| 2 × 996 + 484 | 484 + 996 + 996 | 3 | No | 468 × N_{BPSCS,0,i}_{ₛₛ} | 980 × N_{BPSCS,1,i}_{ₛₛ} | 980 × N_{BPSCS,2,i}_{ₛₛ} | N/A |
| | 996 + 484 + 996 | | No | 980 × N_{BPSCS,0,i}_{ₛₛ} | 468 × N_{BPSCS,1,i}_{ₛₛ} | 980 × N_{BPSCS,2,i}_{ₛₛ} | |
| | 996 + 996 + 484 | | No | 980 × N_{BPSCS,0,i}_{ₛₛ} | 980 × N_{BPSCS,1,i}_{ₛₛ} | 468 × N_{BPSCS,2,i}_{ₛₛ} | |
| 3 × 996 + 484 | 484 + 996 + 996 + 996 | 4 | No | 468 × N_{BPSCS,0,i}_{ₛₛ} | 980 × N_{BPSCS,1,i}_{ₛₛ} | 980 × N_{BPSCS,2,i}_{ₛₛ} | 980 × N_{BPSCS,3,i}_{ₛₛ} |
| | 996 + 484 + 996 + 996 | | No | 980 × N_{BPSCS,0,i}_{ₛₛ} | 468 × N_{BPSCS,1,i}_{ₛₛ} | 980 × N_{BPSCS,2,i}_{ₛₛ} | 980 × N_{BPSCS,3,i}_{ₛₛ} |
| | 996 + 996 + 484 + 996 | | No | 980 × NBPSCS,0,_{ₛₛ} | 980 × N_{BPSCS,1,i}_{ₛₛ} | 468 × N_{BPSCS,2,i}_{ₛₛ} | 980 × N_{BPSCS,3,i}_{ₛₛ} |
| | 996 + 996 + 996 + 484 | | No | 980 × N_{BPSCS,0,i}_{ₛₛ} | 980 × N_{BPSCS,1,i}_{ₛₛ} | 980 × N_{BPSCS,2,i}_{ₛₛ} | 468 × N_{BPSCS,3,i}_{ₛₛ} |
| 2 × 996 | 996 + 996 | 2 | No | 980 × N_{BPSCS,0,i}_{ₛₛ} | 980 × N_{BPSCS,1,i}_{ₛₛ} | N/A | N/A |
| | | | Yes | 490 | 490 | | |
| 3 × 996 | 996 + 996 + 996 | 3 | No | 980 × N_{BPSCS,0,i}_{ₛₛ} | 980 × N_{BPSCS,1,i}_{ₛₛ} | 980 × N_{BPSCS,2,i}_{ₛₛ} | |
| | | | Yes | 490 | 490 | 490 | |
| 4 × 996 | 996 + 996 + 996 + 996 | 4 | No | 980 × N_{BPSCS,0,i}_{ₛₛ} | 980 × N_{BPSCS,1,i}_{ₛₛ} | 980 × N_{BPSCS,2,i}_{ₛₛ} | 980 × N_{BPSCS,3,i}_{ₛₛ} |
| | | | Yes | 490 | 490 | 490 | 490 |

For the case of unequal modulation over 80 MHz frequency subblocks, the round-robin segment parser takes the output bits from a stream parser for a single spatial stream as its input bits. In each round, the segment parser first allocates a certain number of consecutive input bits to the lowest 80 MHz frequency subblock (or RUs in the first 80 MHz frequency subblock), then allocates another certain number of consecutive input bits to the next lowest 80 MHz frequency subblock and so on up to and including the highest 80 MHz frequency subblock. The segment parser then repeats the same round-robin procedure over the L 80 MHz frequency subblocks. The number of consecutive input bits to each frequency subblock is proportional or approximately proportional to the number of occupied tones and the modulation order used in that frequency subblock as defined in Table 2. An 80 MHz frequency subblock is considered not fully occupied if it consists of RUs or MRUs that have a total of 484 or 484+242 occupied tones, but not 996 occupied tones. If a frequency subblock is not fully occupied, that frequency subblock will get all its allocated bits before the other frequency subblocks. At that point, no further bits are outputted by the segment parser for that frequency subblock. For the other frequency subblocks, the number of leftover bits is defined in Table 2, and the proportional round robin parser will continue to process the leftover bits.

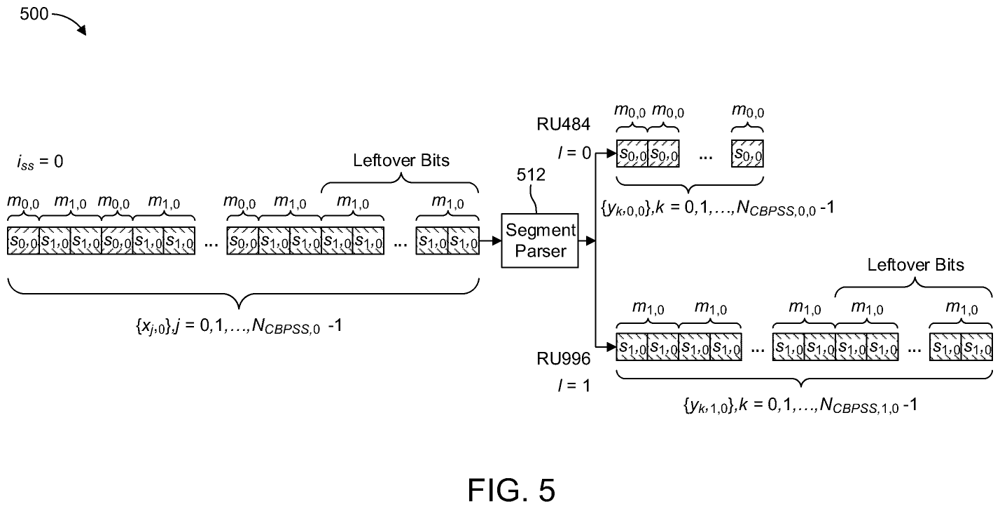

FIG. 5 is a system diagram illustrating an example parser subsystem 500 including a proportional round-robin segment parser 512 with unequal modulation across frequency subblocks for a spatial stream. Round-robin segment parser 512, with unequal modulation across frequency subblocks for a spatial stream, allocates bits alternatingly to a 484-tone RU and a 996-tone RU (each RU is in a respective 80 MHz subblock). The modulation orders for the subcarriers in the 484-tone RU and those in the 996-tone RU are allowed to be different. In the example of FIG. 5, a 996+484-tone MRU has a 484-tone RU in a lower 80 MHz frequency subblock and a 996-tone RU in a higher 80 MHz frequency subblock. In this example, for a given spatial stream, the modulation order for subcarriers in each 80 MHz frequency subblock is the same but different across the two frequency subblocks.

If we denote the input bit sequence of spatial stream iₛₛ (iss=0 in this example) to the segment parser 512 for user u as {x_{j,i}_{ₛₛ}} and the output bit sequence of an 80 MHz frequency subblock (or RU in the 80 MHz frequency subblock l) as {y_{k,l,i}_{ₛₛ}} (l=0.1 and L=2 in this example), the mapping between the input and output sequences before reaching the leftover bits is given by y_{k,l,i}_{ₛₛ}=x_{j,i}_{ₛₛ} where

$$j = ( {\sum }_{i = 0}^{L - 1} {m}_{i , {i}_{s s}} ) ⌊ \frac{k}{{m}_{l , {i}_{s s}}} ⌋ + {\sum }_{i = 0}^{l - 1} {m}_{i , {i}_{s s}} + ( k mod {m}_{l , {i}_{s s}} ) \qquad ( 2 )$$

and where
y_{k,l,i}_{ₛₛ} is bit k of the frequency subblock (or RU in 80 MHz frequency subblock)/for spatial stream iₛₛ. k=0,1, . . . , N_{CBPS,l,i}_{ₛₛ}−nₗ×44×N_{BPSCS,i}_{ₛₛ}−1 when DCM is not used and k=0,1, . . . , N_{CBPSS,l,i}_{ₛₛ}−nₗ×22×N_{BPSCS,l,i}_{ₛₛ}−1 when DCM is used. nₗ is 1 for fully occupied frequency subblock l with nonzero leftover bits, and 0 for partially or fully occupied frequency subblock/with zero leftover bits. I is the frequency subblock index, l=0,1, . . . . L−1. L is the number of frequency subblocks, and L=2 for the example shown in FIG. 5 with 996+484-tone RU. In other examples now shown, L=2 for 996+484+242-tone, 2×996-tone RU or MRU; L=3 for 2×996+484-tone and 3×996-tone RU or MRU; and L=4 for 3×996+484-tone and 4×996-tone RU or MRU. x_{j,i}_{ₛₛ} is bit j of a block of

$${N}_{CBPSS , {i}_{ss}} = {\sum }_{i = 0}^{L - 1} {N}_{CBPSS , i , {i}_{ss}}$$

input vits to the segment parser 512 and j=0,1, . . . , N_{CBPSS,i}_{ₛₛ}−1. m_{i,i}_{ₛₛ} is the number of consecutive input bits assigned to block i for each round of the round robin segment parser 512 and i=0,1, . . . , L−1. Example values of m_{i,i}_{ₛₛ} are given in Table 2. The values of m_{i,i}_{ₛₛ} are proportional or approximately proportional to the number of occupied data subcarriers and the number of coded bits per subcarrier per spatial stream N_{BPSCS,l,i}_{ₛₛ} in each 80 MHz frequency subblock. m_{i,i}_{ₛₛ} is the number of consecutive input bits assigned to block I for each round of the round robin segment parser 512.

$${\sum }_{i = 0}^{l - 1} {m}_{i , {i}_{s s}} = 0 for l = 0.$$

$${s}_{l , {i}_{s s}} = max ( 1 , \frac{{N}_{B P SCS , l , {i}_{ss}}}{2} )$$

in Table 2.

For leftover bits, the mapping between the input and output bit sequences of the segment parser 512 is given by y_{k,l,i}_{ₛₛ}=x_{j,i}_{ₛₛ} where

$$j = ( {\sum }_{i = 0}^{L - 1} {m}_{i , {i}_{s s}} ) ⌊ \frac{{N}_{C B P SS , {l}_{0} , {i}_{s s}}}{{m}_{{l}_{0} , {i}_{s s}}} ⌋ + ( {\sum }_{i = 0 , i \neq {l}_{0}}^{L - 1} {m}_{i , {i}_{s s}} ) ⌊ \frac{{k}^{′}}{{m}_{l , {i}_{s s}}} ⌋ + {\sum }_{i = 0 , i \neq {l}_{0}}^{l - 1} {m}_{i , {i}_{s s}} + ( k mod {m}_{l , {i}_{s s}} ) \qquad ( 3 )$$

and where
k=(N_{CBPSS,i,i}_{ₛₛ}−n₁×44×N_{BPSCS,l,i}_{ₛₛ}), (N_{CBPS,l,i}_{ₛₛ}−nₗ×44× N_{BPSCS,l,i}_{ₛₛ})+1, . . . , N_{CBPS,l,i}_{ₛₛ}−1 when DCM is not used and k=(N_{CBPS,l,i}_{ₛₛ}−nₗ×22×N_{BPSCS,l,i}_{ₛₛ}), (N_{CBPS,l,i}_{ₛₛ}−nₗ×22×N_{BPSCS,l,i}_{ₛₛ})+1, . . . , N_{CBPSS,l,i}_{ₛₛ}−1 when DCM is used. k′=k−(N_{CBPSS,l,i}_{ₛₛ}−nₗ×44×N_{BPSCS,l,i}_{ₛₛ}) when DCM is not used and k′=k−(N_{CBPSS,l,i}_{ₛₛ}−nₗ×22×N_{BPSCS,l,i}_{ₛₛ}) when DCM is used. l₀ is the subblock index with zero leftover bits, i.e.,

$${n}_{{l}_{0}} = 0.$$

$${\sum }_{i = 0 , i \neq {l}_{0}}^{l - 1} {m}_{i , {i}_{s s}} = 0$$

for frequency subblock l=0.

TABLE 2
Segment parser parameters for UEQM over 80 MHz frequency subblocks

| | | | | | | | | Leftover |
|---|---|---|---|---|---|---|---|---|
| | | | | | | | | bits per |
| | | | | | | | | fully |
| | | | | | | | | occupied |
| | RU order (low to | | DCM | | | | | frequency |
| RU or MRU | high frequency) | L | used? | m_{0,i}_{ₛₛ} | m_{1,i}_{ₛₛ} | m_{2,i}_{ₛₛ} | m_{3,iss} | subblock |
| 996 + 484 | 484 + 996 | 2 | No | s_{0,i}_{ₛₛ} | $2 {s}_{1 , {i}_{s s}}$ | N/A | | Subblock 0:0; |
| | | | | | | | | Subblock |
| | | | | | | | | 1:44 × |
| | | | | | | | | N_{BPSCS,1,i}_{ₛₛ} |
| | | | Yes | | | | | Subblock |
| | | | | | | | | 0:0; |
| | | | | | | | | Subblock |
| | | | | | | | | 1:22 |
| | 996 + 484 | | No | $2 {s}_{0 , {i}_{s s}}$ | s_{1,i}_{ₛₛ} | | | Subblock 0:44 × |
| | | | | | | | | N_{BPSCS,0,i}_{ₛₛ}; |
| | | | | | | | | Subblock |
| | | | | | | | | 1:0 |
| | | | Yes | | | | | Subblock |
| | | | | | | | | 0:22; |
| | | | | | | | | Subblock |
| | | | | | | | | 1:0 |
| 996 + 484 + 242 | (242 + 484) + 996 or (484 + 242) + 996 | | No | $3 {s}_{0 , {i}_{s s}}$ | $4 {s}_{1 , {i}_{s s}}$ | | | Subblock 0:0; |
| | | | | | | | | Subblock |
| | | | | | | | | 1:44 × |
| | | | | | | | | N_{BPSCS,1,i}_{ₛₛ} |
| | | | Yes | | | | | Subblock |
| | | | | | | | | 0:0; |
| | | | | | | | | Subblock |
| | | | | | | | | 1:22 |
| | 996 + (242 + 484) or 996 + (484 + 242) | | No | $4 {s}_{0 , {i}_{s s}}$ | $3 {s}_{1 , {i}_{s s}}$ | | | Subblock 0:44 × |
| | | | | | | | | N_{BPSCS,0,i}_{ₛₛ}; |
| | | | | | | | | Subblock |
| | | | | | | | | 1:0 |
| | | | Yes | | | | | Subblock |
| | | | | | | | | 0:22; |
| | | | | | | | | Subblock |
| | | | | | | | | 1:0 |
| 2 × 996 + 484 | 484 + 996 + 996 | 3 | No | s_{0,i}_{ₛₛ} | $2 {s}_{1 , {i}_{s s}}$ | $2 {s}_{2 , {i}_{s s}}$ | N/A | Subblock 0:0; |
| | | | | | | | | Subblock |
| | | | | | | | | l = |
| | | | | | | | | 1, 2:44 × |
| | | | | | | | | N_{BPSCS,l,i}_{ₛₛ} |
| | 996 + 484 + 996 | | No | $2 {s}_{0 , {i}_{s s}}$ | s_{1,i}_{ₛₛ} | $2 {s}_{2 , {i}_{s s}}$ | | Subblock 1:0; |
| | | | | | | | | Subblock |
| | | | | | | | | l = 0,2: |
| | | | | | | | | 44 × |
| | | | | | | | | N_{BPSCS,l,i}_{ₛₛ} |
| | 996 + 996 + 484 | | No | $2 {s}_{0 , {i}_{s s}}$ | $2 {s}_{1 , {i}_{s s}}$ | s_{2,i}_{ₛₛ} | | Subblock 2:0; |
| | | | | | | | | Subblock |
| | | | | | | | | l = |
| | | | | | | | | 0,1:44 × |
| | | | | | | | | N_{BPSCS,l,i}_{ₛₛ} |
| 3 × 996 + 484 | 484 + 996 + 996 + 996 | 4 | No | s_{0,i}_{ₛₛ} | $2 {s}_{1 , {i}_{s s}}$ | $2 {s}_{2 , {i}_{s s}}$ | $2 {s}_{3 , {i}_{s s}}$ | Subblock 0:0; |
| | | | | | | | | Subblock |
| | | | | | | | | l = |
| | | | | | | | | 1, 2, 3:44 × |
| | | | | | | | | N_{BPSCS,l,i}_{ₛₛ} |
| | 996 + 484 + 996 + 996 | | No | $2 {s}_{0 , {i}_{s s}}$ | s_{1,i}_{ₛₛ} | $2 {s}_{2 , {i}_{s s}}$ | $2 {s}_{3 , {i}_{s s}}$ | Subblock 1:0; |
| | | | | | | | | Subblock |
| | | | | | | | | l = |
| | | | | | | | | 0, 2, 3:44 × |
| | | | | | | | | N_{BPSCS,l,i}_{ₛₛ} |
| | 996 + 996 + 484 + 996 | | No | $2 {s}_{0 , {i}_{s s}}$ | $2 {s}_{1 , {i}_{s s}}$ | s_{2,i}_{ₛₛ} | $2 {s}_{3 , {i}_{s s}}$ | Subblock 2:0; |
| | | | | | | | | Subblock |
| | | | | | | | | l = |
| | | | | | | | | 0, 1, 3:44 × |
| | | | | | | | | N_{BPSCS,l,i}_{ₛₛ} |
| | 996 + 996 + 996 + 484 | | No | $2 {s}_{0 , {i}_{s s}}$ | $2 {s}_{1 , {i}_{s s}}$ | $2 {s}_{2 , {i}_{s s}}$ | s_{3,i}_{ₛₛ} | Subblock 3:0; |
| | | | | | | | | Subblock |
| | | | | | | | | l = |
| | | | | | | | | 0, 1, 2:44 × |
| | | | | | | | | N_{BPSCS,l,i}_{ₛₛ} |
| 2 × 996 | 996 + 996 | 2 | No | s_{0,i}_{ₛₛ} | s_{1,i}_{ₛₛ} | N/A | | 0 |
| | | | Yes | | | | | |
| 3 × 996 | 996 + 996 + 996 | 3 | No | s_{0,i}_{ₛₛ} | s_{1,i}_{ₛₛ} | s_{2,i}_{ₛₛ} | N/A | 0 |
| | | | Yes | | | | | |
| 4 × 996 | 996 + 996 + 996 + 996 | 4 | No | s_{0,i}_{ₛₛ} | s_{1,i}_{ₛₛ} | s_{2,i}_{ₛₛ} | s_{3,i}_{ₛₛ} | 0 |
| | | | Yes | | | | | |

As described above, the basic round-robin bit blocks in the segment parser are based on m_{i,i}_{ₛₛ}, which may be different for different spatial stream iₛₛ and may be different for different frequency subblocks index l.

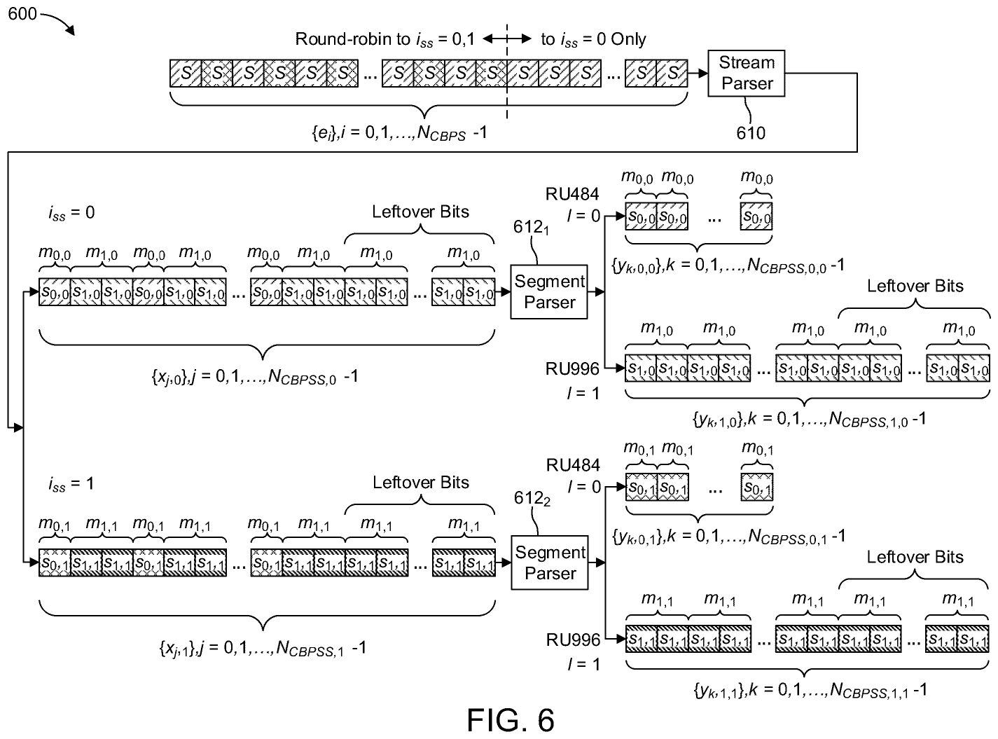

In an example embodiment of a stream parser, a simple stream parser may ignore {m_{l,i}_{ₛₛ}}, the sizes of the basic round-robin bit blocks in the segment parser, and choose a constant s that is a common divisor of all {N_{CBPSS,i}_{ₛₛ}}, where N_{CBPSS,i}_{ₛₛ} is the number of coded bits per OFDM symbol for spatial stream iₛₛ, given hereinbefore in the description of the segment parser. In this case, the stream parser allocates every s consecutive bits of its input bit sequence in a round-robin fashion to spatial streams, as illustrated in FIG. 6. FIG. 6 is a system diagram illustrating an example parser subsystem 600 including a stream parser 610 and segment parsers 6121 and 6122 with unequal modulation across frequency subblocks for a spatial stream. Stream parser 610 assigns the first s consecutive bits of encoded bit sequence {eᵢ}, i=0,1, . . . , N_{CBPS}−1 to spatial stream iₛₛ=0, the next s consecutive bits to spatial stream iₛₛ=1 (repeated up to spatial stream Nₛₛ−1). This round-robin operation is repeated until some spatial stream iₛₛ gets all its assigned N_{CBPSS,i}_{ₛₛ} bits and then this spatial stream is removed from the round-robin operation starting from the next round. The stream parser 610 repeats the above procedure until all spatial streams get the appropriate number of bits. In other words, stream parser 610 allocates s-bit blocks between two alternating spatial streams and then assigns the rest of bits to spatial stream iₛₛ=0 after spatial stream iₛₛ=1 gets all its needed bits. The numbers of bits needed by the two spatial streams are determined by the different modulation orders assigned to different spatial streams at different frequency subblocks. The mapping between the input bit sequence {eᵢ} and the output bit sequence {x_{j,i}_{ₛₛ}} at spatial stream iss of stream parser 610 is given by x_{j,i}_{ₛₛ}=eᵢ where

$$i = {\sum }_{k = 0}^{{i}_{s s} - 1} I ( j < {N}_{CBPSS , k} ) \cdot s + S \cdot ⌊ \frac{j}{s} ⌋ + j mod s - {\sum }_{k = 0 , k \neq {i}_{s s}}^{{N}_{s s} - 1} {\vert ⌊ \frac{j}{s} ⌋ \cdot s - {N}_{CBPSS , k} \vert}^{+} \qquad ( 4 )$$

$$and where$$

$$j = 0 , … , {N}_{CBPSS , {i}_{s s}} - 1 ,$$

$${i}_{s s} = 0 , 1 , … , {N}_{s s} - 1 ,$$

$$i = 0 , 1 , … , {N}_{CBPS} - 1 ,$$

I(j<N_{CBPSS,k}) is an indicator function, which equals to 1 when j<N_{CBPSS,k} is true, and 0 otherwise, s is a selected common divisor of {N_{CBPSS,i}_{ₛₛ}}, i.e., N_{CBPSS,i}_{ₛₛ} mod s=0 for all iₛₛ, S=Nₛₛ·s, and

$${\vert ⌊ \frac{j}{s} ⌋ \cdot s - {N}_{CBPSS , k} \vert}^{+} = max ( ⌊ \frac{j}{s} ⌋ \cdot s - {N}_{CBPSS , k} , 0 ) .$$

The example of FIG. 6 includes simplified stream parser 610 concatenated with two segment parsers 612₁ and 612₂, each for a spatial stream and a 996+484-tone MRU where the 484-tone RU is in a lower 80 MHz frequency subblock and the 996-tone RU is in a higher 80 MHz frequency subblock. The modulation order for subcarriers in each frequency subblock is the same but different across the two spatial streams and two frequency subblocks in this example.

In another example embodiment of a stream parser, the stream parser may consider spatial stream parsing based on the basic bit block sizes

$$\{ {s}_{l , {i}_{s s}} = max ( 1 , \frac{{N}_{BPSCS , l , {i}_{ss}}}{2} ) \}$$

used in the segment parser and other parameters defined for the segment parser as in Table 1 and Table 2. This is different from the equal-modulation stream parser and segment parser of 802.11be for which the basic bit block size is a single

$$s = max ( 1 , \frac{{N}_{BPSCS}}{2} ) .$$

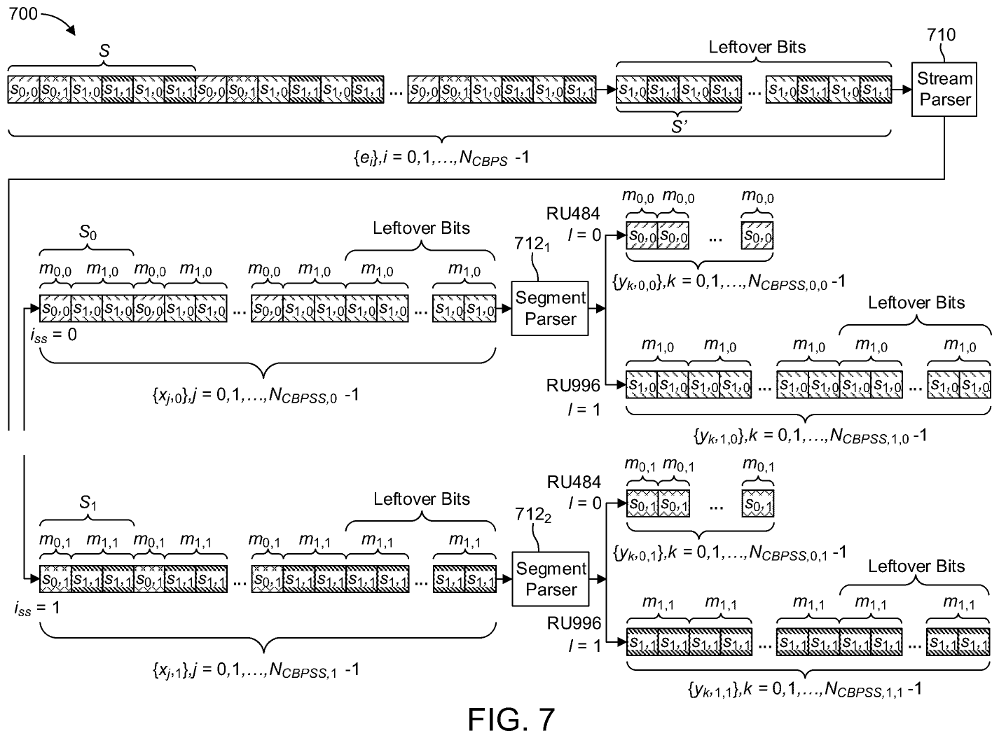

In this method, the stream parser operates in a round-robin fashion alternating through spatial streams such that the number of bits allocated in each round may be different depending on not only which spatial stream but also which frequency subblock these bits will go to eventually after the segment parser. We first explain the process in more detail using the example shown in FIG. 7, where there are two spatial streams and two frequency subblocks. FIG. 7 is a system diagram illustrating an example parser subsystem 700 including a stream parser 710 and segment parsers 712₁ and 712₂ with unequal modulation across frequency subblocks for a spatial stream. FIG. 7 includes an example of a general stream parser 710 concatenated with two segment parsers 712₁ and 712₂, each for a spatial stream and a 996+484-tone MRU where the 484-tone RU is in a lower 80 MHz frequency subblock and the 996-tone RU is in a higher 80 MHz frequency subblock. The modulation order for subcarriers in each frequency subblock is the same but different across the two spatial streams and two frequency subblocks in this example.

For this example, the stream parser 710 first assigns s_{0,0} bits to spatial stream iₛₛ=0, where s_{0,0} is the basic bit-block size for spatial stream iₛₛ=0 and frequency subblock l=0. The stream parser 710 then assigns s_{0,1} bits to spatial stream iₛₛ=1, where s_{0,1} is the basic bit-block size for spatial stream iₛₛ=1 and frequency subblock l=0, which completes one round of parsing bits into streams. In the next round, s_{1,0} bits are assigned to spatial stream iₛₛ=0 and s_{1,1} bits are assigned to spatial stream iₛₛ=1 because the bits will be parsed to frequency subblock l=1 later by their respective segment parsers 712₁ and 712₂. In this example, a third round repeats the second round because the basic bit-block size required by the segment parser parsers 712₁ and 712₂ for frequency subblock l=1 is m_{1,i}_{ₛₛ}=2s_{1,i}_{ₛₛ}. Then the round-robin operations of the first three rounds are repeated till all the bits for frequency subblock I=0 are assigned. The remaining bits at the input of the stream parser 710 are assigned to frequency subblock (=1 only. These bits are the “leftover” bits, as described hereinbefore with respect to a segment parser. In the next round, s_{1,0} are assigned to spatial stream iₛₛ=0 and s_{1,1} bits go to spatial stream iₛₛ=1. This operation is then repeated in a round-robin fashion till all the remaining bits for frequency subblock I=1 are assigned as well.

In general, the mapping between the input bit sequence {eᵢ} and the output bit sequence {x_{j,i}_{ₛₛ}} at spatial stream iₛₛ of stream parser 710 is given by Equation (5) before reaching the leftover bits in the segment parser 712₁ and 712₂, and by Equation (6) for the leftover bits. For non-leftover bits, x_{j,i}_{ₛₛ}=eᵢ where

$$i = S \cdot ⌊ \frac{j}{{S}_{{i}_{s s}}} ⌋ + {\sum }_{l = 0}^{\tilde{l} - 1} {\sum }_{k = 0}^{{N}_{s s} - 1} {m}_{l , k} + ⌊ \frac{{j}^{′}}{{s}_{\tilde{l} , {i}_{ss}}} ⌋ \cdot {\sum }_{k = 0}^{{N}_{s s} - 1} {s}_{\tilde{l} , k} + {\sum }_{k = 0}^{{i}_{s s} - 1} {s}_{\tilde{l} , k} + {j}^{′} mod {s}_{\tilde{l} , {i}_{ss}} \qquad ( 5 )$$

$$\begin{matrix}if j = 0 , 1 , … , min ( {N}_{CBPSS , {i}_{s s}} , {S}_{{i}_{ss}} \cdot {N}_{CBPSS , {l}_{0} , {i}_{s s}} / {m}_{{l}_{0} , {i}_{s s}} ) - 1 , where \\ {i}_{s s} = 0 , 1 , … , {N}_{s s} - 1 , \\ i = 0 , 1 , … , {N}_{CBPS} - 1 ,\end{matrix}$$

where

$$S = {Σ}_{l = 0}^{L - 1} {Σ}_{k = 0}^{{N}_{s s} - 1} {m}_{l , k} , {S}_{{i}_{s s}} = {Σ}_{l = 0}^{L - 1} {m}_{l , {i}_{s s}} , and S = {Σ}_{k = 0}^{{N}_{s s} - 1} {S}_{k} ,$$

m_{l,k} and s_{l,k} are the values defined in Table 2, \tilde{l} is a frequency subblock index among {0,1, . . . ,L−1} that satisfies

$${\sum }_{l = 0}^{\tilde{l} - 1} {m}_{l , {i}_{s s}} \leq j - {S}_{{i}_{s s}} \cdot ⌊ \frac{j}{{s}_{{i}_{ss}}} ⌋ < {\sum }_{l = 0}^{\tilde{l}} {m}_{l , {i}_{s s}} and {\sum }_{l = 0}^{\tilde{l} - 1} ( \cdot ) = 0 if \tilde{l} = 0 , {j}^{′} = j - {S}_{{i}_{s s}} \cdot ⌊ \frac{j}{{s}_{{i}_{ss}}} ⌋ - {\sum }_{l = 0}^{\tilde{l} - 1} {m}_{l , {i}_{s s}} , {\sum }_{k = 0}^{{i}_{s s} - 1} {s}_{\tilde{l} , k} = 0 if {i}_{ss} = 0 , {N}_{CBPSS , \tilde{l} , {i}_{s s}}$$

is the number of coded bits at spatial stream iₛₛ for the lₜₕ frequency subblock as defined in Table 2, N_{CBPSS,i}_{ₛₛ} is the number of coded bits at spatial stream iₛₛ required for all L frequency subblocks and

$${N}_{CBPSS , {i}_{s s}} = {\sum }_{l = 0}^{L - 1} {N}_{CBPSS , l , {i}_{s s}} ,$$

and l₀ is the frequency subblock index with zero leftover bits as defined in Table 2.

For leftover bits, x_{j,i}_{ₛₛ}=eᵢ where

$$i = S \cdot \frac{{N}_{CBPSS , {l}_{0} , {i}_{ss}}}{{m}_{{l}_{0} , {i}_{s s}}} + {s}^{′} \cdot ⌊ \frac{{j}^{″}}{{S}_{{i}_{s s}}^{′}} ⌋ + {\sum }_{l = 0 , l \neq {l}_{0}}^{{\tilde{l}}^{′} - 1} {\sum }_{k = 0}^{{N}_{s s} - 1} {m}_{l , k} + ⌊ \frac{{j}^{′′′}}{{S}_{{\tilde{l}}^{′} , {i}_{s s}}} ⌋ \cdot {\sum }_{k = 0}^{{N}_{s s} - 1} {s}_{{\tilde{l}}^{′} , k} + {\sum }_{k = 0}^{{i}_{s s} - 1} {s}_{{\tilde{l}}^{′} , k} + {j}^{′′′} mod {s}_{{\tilde{l}}^{′} , {i}_{s s}} \qquad ( 6 )$$

$$if j = {S}_{{i}_{s s}} \cdot \frac{{N}_{CBPSS , {l}_{0} , {i}_{ss}}}{{m}_{{l}_{0} , {i}_{ss}}} , {S}_{{i}_{s s}} \cdot \frac{{N}_{CBPSS , {l}_{0} , {i}_{ss}}}{{m}_{{l}_{0} , {i}_{ss}}} + 1 , … , {N}_{CBPSS , {i}_{s s}} - 1 ,$$

where

$${S}_{{i}_{s s}}^{′} = {Σ}_{l = 0 , l \neq {l}_{0}}^{L - 1} {m}_{l , {i}_{s s}} , {S}^{′} = {Σ}_{k = 0}^{{N}_{s s} - 1} {S}_{k}^{′} , {j}^{″} = j - {S}_{{i}_{s s}} \cdot \frac{{N}_{CBPSS , {l}_{0} , {i}_{ss}}}{{m}_{{l}_{0} , {i}_{ss}}} ,$$

\tilde{l}′ is a frequency subblock index among {0,1, . . . , L−1}\l₀ that satisfies

$${\sum }_{l = 0 , l \neq {l}_{0}}^{{\tilde{l}}^{′} - 1} {m}_{l , {i}_{s s}} \leq {j}^{″} - {S}_{{i}_{s s}}^{′} \cdot ⌊ \frac{{j}^{″}}{{S}_{{i}_{s s}}^{′}} ⌋ < {\sum }_{l = 0 , l \neq {l}_{0}}^{{\tilde{l}}^{′}} {m}_{l , {i}_{s s}} , and {\sum }_{l = 0 , l \neq {l}_{0}}^{{\tilde{l}}^{′} - 1} ( \cdot ) = 0 if {\tilde{l}}^{′} = 0 , or {\tilde{l}}^{′} = 1 and {l}_{0} = 0 , and {j}^{′′′} = {j}^{″} - {S}_{{i}_{s s}}^{′} \cdot ⌊ \frac{{j}^{″}}{{S}_{{i}_{s s}}^{′}} ⌋ - {\sum }_{l = 0 , l \neq {l}_{0}}^{{\tilde{l}}^{′} - 1} {m}_{l , {i}_{s s}} .$$

The case of UEQM over 80 MHz frequency subblocks only (i.e., for any given 80 MHz frequency subblock the modulation order is the same across the spatial streams) is a special case of the general case of UEQM over both spatial streams and 80 MHz frequency subblocks described above. In this special case, N_{BPSCS,l,i}_{ₛₛ}, N_{CBPSS,l,i}_{ₛₛ}, m_{l,i}_{ₛₛ}, and s_{l,i}_{ₛₛ} are the same for all iₛₛ, but may still be different for different frequency subblock l. Equations (2)-(6) and Table 1 and Table 2 are still applicable with the appropriate values of the parameters N_{BPSCS,l,i}_{ₛₛ}, N_{CBPSS,l,i}_{ₛₛ}, m_{l,i}_{ₛₛ}, and s_{i,l}_{ₛₛ}.

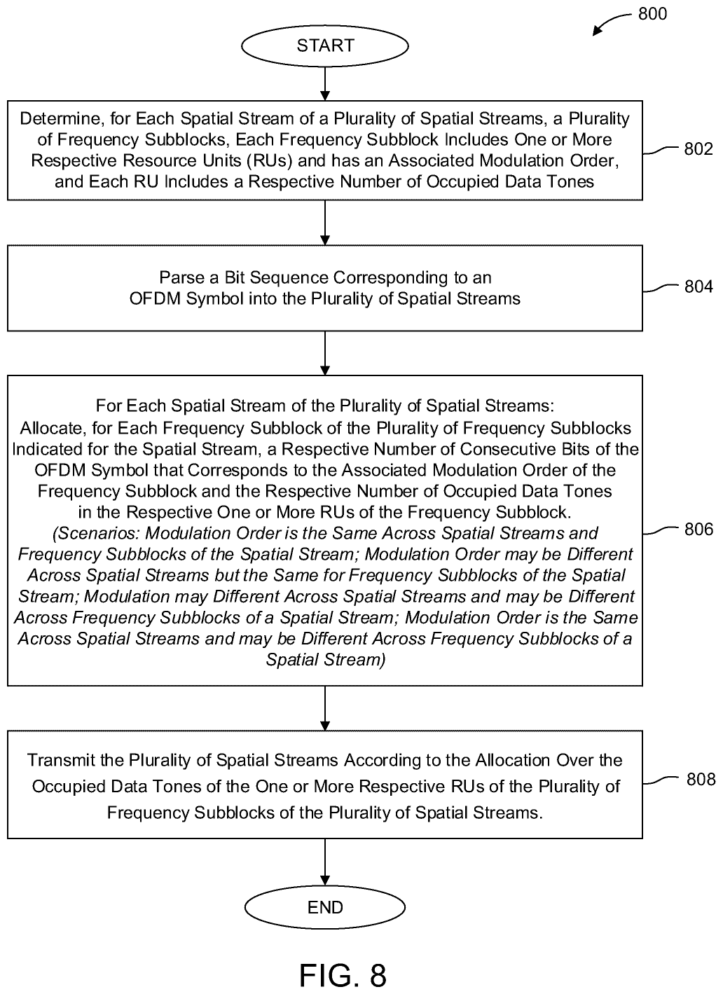

FIG. 8 is a flow diagram illustrating an example procedure 800 for parsing a bit stream for unequal modulation over spatial streams and frequency subblocks. Example procedure 800 may be performed by a transmitter including a stream parser and segment parsers, and the transmitter may be part of a STA (WTRU). At 802, the STA may indicate, for each spatial stream of a plurality of spatial streams, a plurality of frequency subblocks, where each frequency subblock of the plurality of frequency subblocks includes one or more respective resource units (RUs) and has an associated modulation order, and each RU of the one or more respective RUs includes a respective number of occupied data tones. At 804, the STA may parse a bit sequence corresponding to an OFDM symbol into the plurality of spatial streams. At 806, the STA may, for each spatial stream of the plurality of spatial streams: allocate, for each frequency subblock of the plurality of frequency subblocks determined for the spatial stream, a respective number of consecutive bits of the OFDM symbol that corresponds to the associated modulation order of the frequency subblock and the respective number of occupied data tones in the respective one or more RUs of the frequency subblock. The different scenarios handled by the parsing procedures disclosed herein include: modulation order is the same across spatial streams and frequency subblocks of the spatial stream; modulation order may be different across spatial streams but the same for frequency subblocks of the spatial stream; modulation may different across spatial streams and may be different across frequency subblocks of a spatial stream; and modulation order is the same across spatial streams and may be different across frequency subblocks of a spatial stream. At 808, the STA may transmit the plurality of spatial streams according to the allocation over the occupied data tones of the one or more respective RUs of the plurality of frequency subblocks of the plurality of spatial streams.

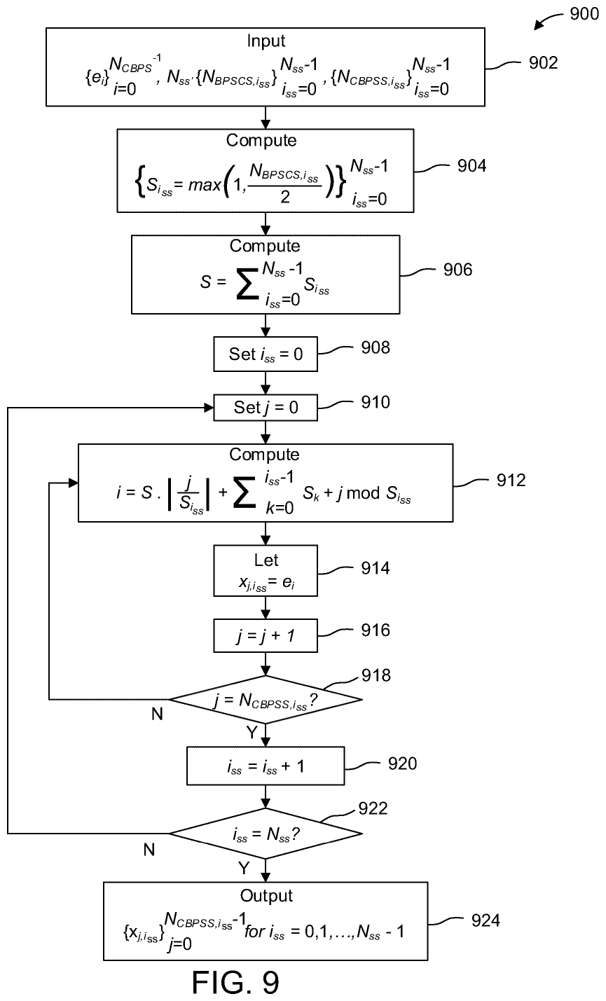

FIG. 9 is a flow diagram illustrating an example procedure 900 for parsing a bit stream for unequal modulation over spatial streams only. Example procedure 900 may be performed by a stream parser or a combination stream/segment parser in a transmitter. The parameters and equations shown in procedure 900 are described in detail hereinbefore. At 902, stream parser receives or determines input bit sequence

$${\{ {e}_{i} \}}_{i = 0}^{{N}_{CBPS} - 1}$$

and parsing parameters, including the number of spatial streams Nₛₛ, the number of coded bits per OFDM symbol for spatial stream iₛₛ

$${\{ {N}_{CBPSS , {i}_{s s}} \}}_{{i}_{s s} = 0}^{{N}_{s s} - 1} ,$$

and the number of coded bits per subcarrier for spatial stream

$${i}_{s s} {\{ {N}_{BPSCS , {i}_{s s}} \}}_{{i}_{s s} = 0}^{{N}_{s s} - 1} .$$

At 904, the stream parser calculates consecutive bits sᵢ_{ₛₛ} allocated to spatial stream iₛₛ according to

$${\{ {s}_{{i}_{s s}} = max ( 1 , \frac{{N}_{BPSCS , {i}_{ss}}}{2} ) \}}_{{i}_{s s} = 0}^{{N}_{s s} - 1} .$$

At 906, the stream parser calculates the number of assigned bits over all spatial streams according to

$$S = {Σ}_{{i}_{s s} = 0}^{{N}_{s s} - 1} {s}_{{i}_{s s}} .$$

At 908, the stream parser starts with the first spatial stream iₛₛ=0 as its current spatial stream for processing. At 910, the stream parser starts with the first output bit j=0 of the current spatial stream as its current output bit. At 912, the stream parser calculates the bit index of the current output bit in the input sequence according to Equation (1). At 914, the stream parser outputs the current output bit according to the input bit index calculated in 912. At 916, the current output bit index j is increased by 1. At 918, the stream parser checks if the current output bit index equals to the number of bits needed for the current spatial stream. If not, the stream parser returns to step 912 to repeat the process. If yes, at 920, the current spatial stream index is increased by 1. At 922, the stream checks if the current spatial stream index iₛₛ is equal to the number of spatial streams. If not, the stream parser returns to step 910 to start with the first output bit for the next spatial stream. If yes, at 924, the stream parser output all the parsed bits in each spatial stream

$${\{ {x}_{j , {i}_{s s}} \}}_{j = 0}^{{N}_{C B PSS , {i}_{ss}} - 1}$$

for iₛₛ=0, . . . , Nₛₛ−1.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A station (STA) comprising:
a transceiver; and
a processor,
wherein the transceiver and processor are configured to:
determine, for each spatial stream of a plurality of spatial streams, a plurality of frequency subblocks, wherein each frequency subblock of the plurality of frequency subblocks includes one or more respective resource units (RUs) and has an associated modulation order, and each RU of the one or more respective RUs includes a respective number of occupied data tones;
parse a bit sequence corresponding to an OFDM symbol into the plurality of spatial streams; and
for each spatial stream of the plurality of spatial streams:
allocate, for each frequency subblock of the plurality of frequency subblocks determined for the spatial stream, a respective number of consecutive bits of the OFDM symbol that corresponds to the associated modulation order of the frequency subblock and the respective number of occupied data tones in the respective one or more RUs of the frequency subblock.

2. The STA of claim 1, wherein the transceiver and processor are further configured to:
transmit the plurality of spatial streams according to the allocation over the occupied data tones of the one or more respective RUs of the plurality of frequency subblocks of the plurality of spatial streams.

3. The STA of claim 1, wherein, for each spatial stream of the plurality of spatial streams:
at least two of the plurality of frequency subblocks determined for the spatial stream have different associated modulation orders.

4. The STA of claim 1, wherein, for each spatial stream of the plurality of spatial streams:
the plurality of frequency subblocks determined for the spatial stream have a same modulation order.

5. The STA of claim 1, wherein at least two of the plurality of spatial streams have different modulation orders.

6. The STA of claim 1, wherein the plurality of spatial streams have a same modulation order.

7. The STA of claim 1, wherein the allocation, for each frequency subblock of the plurality of frequency subblocks determined for the spatial stream, of the respective number of consecutive bits of the OFDM symbol is repeated in a round robin over the plurality of frequency subblocks, and wherein the allocation terminates for a frequency subblock that is not fully occupied before a frequency subblock that is fully occupied.

8. The STA of claim 1, wherein the plurality of frequency subblocks are 20 MHz, 40 MHz, 80 MHz, or 160 MHz wide.

9. The STA of claim 1, wherein the one or more respective RUs include a multiple RU (MRU).

10. The STA of claim 1, wherein the bit sequence {eᵢ}, i=0,1, . . . , N_{CBPS}−1 and has N_{CBPS} bits, Nₛₛ is the number of spatial streams in the plurality of spatial streams iₛₛ=0, 1, . . . , Nₛₛ−1, N_{CBPSS,i}_{ₛₛ} is the number of coded bits of the OFDM symbol for spatial stream iₛₛ of the plurality of spatial streams, sis is the number of consecutive bits allocated to spatial stream iₛₛ for iₛₛ=0, 1, . . . , Nₛₛ−1, and wherein the bit sequence is parsed into the plurality of bit streams so that bit with index i of the bit sequence {eᵢ} is assigned to bit with index j of output bit sequence {x_{j,i}_{ₛₛ}} of spatial stream iₛₛ according to x_{j,i}_{ₛₛ}=eᵢ where
$$\begin{matrix}i = S \cdot ⌊ \frac{j}{{s}_{{i}_{ss}}} ⌋ + {\sum }_{k = 0}^{{i}_{s s} - 1} {s}_{k} + j mod {s}_{{i}_{s s}} \\ {i}_{s s} = 0 , 1 , … , {N}_{s s} - 1 \\ i = 0 , 1 , … , {N}_{C B P S} - 1 \\ and \\ j = 0 , 1 , … , {N}_{CBPSS , {i}_{ss}} - 1 .\end{matrix}$$

11. A method performed by a station (STA), the method comprising:
determining, for each spatial stream of a plurality of spatial streams, a plurality of frequency subblocks, wherein each frequency subblock of the plurality of frequency subblocks includes one or more respective resource units (RUs) and has an associated modulation order, and each RU of the one or more respective RUs includes a respective number of occupied data tones;
parsing a bit sequence corresponding to an OFDM symbol into the plurality of spatial streams; and
for each spatial stream of the plurality of spatial streams:
allocating, for each frequency subblock of the plurality of frequency subblocks determined for the spatial stream, a respective number of consecutive bits of the OFDM symbol that corresponds to the associated modulation order of the frequency subblock and the respective number of occupied data tones in the respective one or more RUs of the frequency subblock.

12. The method of claim 11, further comprising:
transmitting the plurality of spatial streams according to the allocation over the occupied data tones of the one or more respective RUs of the plurality of frequency subblocks of the plurality of spatial streams.

13. The method of claim 11, wherein, for each spatial stream of the plurality of spatial streams:
at least two of the plurality of frequency subblocks determined for the spatial stream have different associated modulation orders.

14. The method of claim 11, wherein, for each spatial stream of the plurality of spatial streams:
the plurality of frequency subblocks determined for the spatial stream have a same modulation order.

15. The method of claim 11, wherein at least two of the plurality of spatial streams have different modulation orders.

16. The method of claim 11, wherein the plurality of spatial streams have a same modulation order.

17. The method of claim 11, wherein the allocation, for each frequency subblock of the plurality of frequency subblocks determined for the spatial stream, of the respective number of consecutive bits of the OFDM symbol is repeated in a round robin over the plurality of frequency subblocks, and wherein the allocation terminates for a frequency subblock that is not fully occupied before a frequency subblock that is fully occupied.

18. The method of claim 11, wherein the plurality of frequency subblocks are 20 MHz, 40 MHz, 80 MHz, or 160 MHz wide.

19. The method of claim 11, wherein the one or more respective RUs include a multiple RU (MRU).

20. The method of claim 11, wherein the bit sequence {eᵢ}, i=0,1, . . . , N_{CBPS}−1 and has N_{CBPS} bits, Nₛₛ is the number of spatial streams in the plurality of spatial streams iₛₛ=0,1, . . . , Nₛₛ−1, N_{CBPSS,i}_{ₛₛ} is the number of coded bits of the OFDM symbol for spatial stream iₛₛ of the plurality of spatial streams, sis is the number of consecutive bits allocated to spatial stream iₛₛ for iₛₛ=0,1, . . . , Nₛₛ−1, and wherein the bit sequence is parsed into the plurality of bit streams so that bit with index i of the bit sequence {eᵢ} is assigned to bit with index j of output bit sequence {x_{j,i}_{ₛₛ}} of spatial stream iₛₛ according to x_{j,i}_{ₛₛ}=eᵢ where
$$\begin{matrix}i = S \cdot ⌊ \frac{j}{{s}_{{i}_{ss}}} ⌋ + {\sum }_{k = 0}^{{i}_{s s} - 1} {s}_{k} + j mod {s}_{{i}_{s s}} \\ {i}_{s s} = 0 , 1 , … , {N}_{s s} - 1 \\ i = 0 , 1 , … , {N}_{C B P S} - 1 \\ and \\ j = 0 , 1 , … , {N}_{CBPSS , {i}_{ss}} - 1 .\end{matrix}$$
